(19) United States
(12) Patent Application Publication
(10) Pub. No.: US 2005/0140233 A1
(43) Pub. Date: Jun. 30, 2005

(54) Air blower apparatus

(75) Inventors: Tomonori Kojima, Kawasaki-shi (JP); Hisao Igarashi, Kawasaki-shi (JP); Takushi Fujioka, Kawasaki-shi (JP); Yoichi Tanabe, Kawasaki-shi (JP); Hidetaka Terakubo, Kawasaki-shi (JP); Takayuki Shinohara, Kawasaki-shi (JP); Tomohiro Kashiwagi, Kawasaki-shi (JP); Masaki Yamada, Kawasaki-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: FUJITSU GENERAL LIMITED, Kawasaki-shi (JP)

(21) Appl. No.: 11/002,229

(22) Filed: Dec. 3, 2004

(30) Foreign Application Priority Data
Dec. 10, 2003 (JP) 2003-411289

(51) Int. Cl. H02K 1/32

(52) U.S. Cl. 310/156.37; 310/268; 310/112; 310/114; 417/423.7; 417/410.1

(57) ABSTRACT

There is provided, at a low cost, an air blower apparatus capable of increasing the air blowing capability without an increase in size of an electronic motor, and having a high assembling ability. An electronic motor 3 is an axial gap electronic motor in which a rotor 32 and a stator 31 of the electronic motor are arranged opposedly with a predetermined gap along the rotation axis direction of the rotor, and coaxially supports an air blowing fan 2 on an attaching surface of the rotor 32 opposite to the stator.

### TECHNICAL FIELD

The present invention relates to an air blower apparatus in which an electronic motor and an air blowing fan are integrated and, more particularly, to connecting means for connecting an electronic motor to an air blowing fan.

### BACKGROUND ART

For the purposes of a smaller number of parts, more efficient assembling work, and the like, there has been used an air blower apparatus in which an electronic motor and an air blowing fan are assembled integrally in advance. This air blower apparatus is built in a system body such as an air conditioner as air blowing means, by which the whole of the system can be made smaller in size and lighter in weight and also the cost can be reduced.

As one example of an air blower apparatus of this type, for example, Patent Document 1 (Japanese Patent Application Publication No. H10-117462) has disclosed an air blower apparatus in which a rotating shaft provided in an end portion of a line flow fan (Cross-flow fan) extends into a stator of an inner rotor electronic motor, and a rotor of the electronic motor is installed integrally to the extending portion.

Also, Patent Document 2 (Japanese Patent Application Publication No. H9-247899) has disclosed an air blower apparatus using what is called an axial gap electronic motor in which a rotor and stator of an electronic motor are opposedly arranged in the axial direction of an output shaft. In this example, the axial gap electronic motor is of an air core inductor type.

Also, as another mode, Patent Document 3 (Japanese Patent Application Publication No. 2001-295788) has disclosed a method in which a rotor of an outer rotor electronic motor is used as a hub, and a turbofan or an axial flow fan is installed integrally to the hub.

According to this method, the electronic motor and the fan are connected to each other commonly by one rotating shaft system, so that each of the electronic motor and fan need not have a respective rotating shaft. Therefore, special-purpose connecting means is not needed, and further the length in the axial direction can be shortened, so that a small-size and lightweight air blower apparatus can be provided.

However, the above-described related art still has unsolved problems as described below. In the case where the line flow fan as described in Patent Document 1 is used, since the inner rotor electronic motor is used, the stator and rotor must be extended in the axial direction when a high output is obtained. However, if the axial lengths of the stator and rotor are increased, the length of the fan is shortened relatively, which reduces the air blowing capability.

Also, in the case where the electronic motor is a DC electronic motor, a high output can be obtained by making the magnetic flux density of a rotor magnet high. However, if the magnetic flux density is made high, dust is liable to be attracted to the rotor magnet, which causes poor contact. Also, when the stator is inserted for assembling, the stator collides with a fan casing or the rotor due to a magnetic attraction force, which may decrease the rotation accuracy or may cause initial failure.

Further, in the case of the air blower apparatus described in Patent Document 2, since the axial gap electronic motor of an air core inductor type is used, there arises a problem in that a high magnetic flux density is not obtained, and therefore a high output and high efficiency cannot be achieved. Also, since a winding is arranged on a circuit board, and the circuit board is installed to the casing of equipment, the air blower apparatus is disadvantageous in terms of vibration and strength.

In the case where the outer rotor electronic motor described in Patent Document 3 is used, likewise, when a high output is obtained, the axial dimension increases, so that a fan boss portion becomes large. Accordingly, the vent resistance increases, and resultantly the air blow performance decreases.

### SUMMARY OF THE INVENTION

The present invention has been made to solve the above-described problems, and accordingly an object thereof is to provide, at a low cost, an air blower apparatus capable of increasing the air blowing capability without an increase in size of an electronic motor, and having a high assembling ability.

To achieve the above object, the present invention has some features as described below. The invention of a first aspect is characterized in that in an air blower apparatus in which an electronic motor and an air blowing fan are assembled integrally via predetermined connecting means, the electronic motor is an axial gap electronic motor in which a rotor and a stator are arranged opposedly with a predetermined gap along the rotation axis direction of the rotor; the rotor is provided in a pair at the right and left with respect to the stator; and to at least one of the rotors, the air blowing fan is coaxially attached via the connecting mean.

According to this invention, since the axial dimension is short, the electronic motor is made an axial gap electronic motor, and the connecting means is provided on the rotor thereof to directly attach the air blowing fan thereto, by which the size of electronic motor can be reduced, and accordingly the air blowing fan can be increased in size. Also, the fan can be attached to both of the rotors, so that the air blowing capability can further be increased.

The invention of a second aspect is characterized in that the connecting means consists of an engagement convex portion formed on either one of the attaching surfaces of the rotor and the air blowing fan and an engagement concave portion formed in the other of them as an mating element of the engagement convex portion.

According to this invention, as the connecting means, the engagement convex portion is provided on either one of the attaching surfaces of the rotor and the air blowing fan, and the engagement concave portion mating with the engagement convex portion is provided in the other of them, so that the air blowing fan can be attached directly to the rotor. The arrangement positions of the engagement concave portion and the engagement convex portion are not subject to any special restriction if these portions are provided at positions at which these portions engage with each other.

The invention of a third aspect is characterized in that the connecting means is a magnet coupling. According to this invention, by using the magnet coupling as the connecting means between the air blowing fan and the rotor, the air blowing fan can be attached to the rotor by a simpler method.

The invention of a fourth aspect is characterized in that a bearing is provided in a central portion of the stator, and the rotor is supported by the bearing via a radial bearing. According to this invention, since the stator is pivotally supported directly on the stator via the radial bearing, unlike the conventional apparatus, an output shaft is not needed, so that accordingly the cost can further be reduced.

The invention of a fifth aspect is characterized in that the control of the electronic motor is wide-angle energization not smaller than 120° and smaller than 180°. According to this invention, by satisfying the above-described range, an optimum torque curve is obtained, and hence the maximum torque can be obtained.

The invention of a sixth aspect is characterized in that a fan casing for covering the air blowing fan is further provided, and the fan casing is also used as a bracket for fixing the stator. According to this invention, since the fan casing of the air blowing fan is also used as the bracket covering an internal mechanism of the electronic motor, a separate bracket is not needed, so that accordingly the cost can further be reduced.

The invention of a seventh aspect is characterized in that an elastic member is interposed between the air blowing fan and the fan casing. According to this invention, since the air blowing fan is fixed to the fan casing via the elastic member, the vibration proofing ability can further be increased.

The invention of an eighth aspect is characterized in that the rotor is also used as one end plate in the axial direction of the air blowing fan. According to this invention, since the rotor of electronic motor is also used as the end plate of air blowing fan, the cost can further be reduced, and also the manpower for assembly can also be decreased.

The invention of a ninth aspect is characterized in that the fan casing is subjected to drip-proofing treatment and/or dust-proofing treatment. According to this invention, since the fan casing is subjected to drip-proofing treatment and dust-proofing treatment, the electronic motor can be prevented from being damaged by foreign matters such as waterdrop and dust intruding into the interior thereof.

The invention of a tenth aspect is characterized in that the stator has a plurality of core members each having a stator iron core in the interior, and the core members are connected to each other in a ring shape along the direction of rotation of the rotor. According to this invention, since one stator is formed by combining the core members with each other, all of the assembling ability, productivity, and electronic motor properties are improved significantly as compared with those in the case of the integrated formation.

The invention of an eleventh aspect is characterized in that each of the core members is formed with a bobbin-shaped insulator including a flange for winding a coil, and the insulator is provided with core connecting means for connecting the adjacent core members to each other. According to this invention, by providing the insulator, the winding properties of coil are improved, and also the assembling ability between the individual core members is increased.

### BRIEF DESCRIPTION OF THE DRAWINGS

FIG. 1 is a sectional view schematically showing an internal construction of an air blower apparatus in accordance with a first embodiment of the present invention;

FIG. 2 is a sectional view schematically showing an internal construction of an electronic motor in accordance with the first embodiment;

FIG. 3 is a side view of an electronic motor in accordance with the first embodiment;

FIG. 4 is a sectional view showing a modification of an air blower apparatus in accordance with the first embodiment;

FIG. 5 is a sectional view of an electronic motor for the modification shown in FIG. 2;

FIG. 6 is a sectional view showing a state in which an electronic motor and an air blowing fan are connected to each other by using a magnet coupling;

FIG. 7 is an exploded sectional view for explaining the construction of coupling;

FIG. 8 is a side view of an air blowing fan having a magnet coupling;

FIG. 9 is a sectional view schematically showing an internal construction of an air blower apparatus in accordance with a second embodiment of the present invention;

FIG. 10 is a sectional view showing a modification of the second embodiment;

FIG. 11 is a schematic sectional view showing an internal construction of an axial gap electronic motor used for an air blower apparatus of the present invention;

FIG. 12 is a side view showing a stator core that an axial gap electronic motor has;

FIG. 13 is a plan view of a stator core of an axial gap electronic motor;

FIG. 14A is a front view of a core member contained in a stator core of an axial gap electronic motor;

FIG. 14B is a plan view of a core member;

FIG. 14C is a right side view of a core member;

FIG. 14D is a bottom view of a core member; and

FIG. 15 is a sectional view taken along the line z-z of a core member.

### DETAILED DESCRIPTION

Embodiments of the present invention will now be described with reference to the accompanying drawings. An air blower apparatus 1a includes an air blowing fan 2 including a cross flow fan (line flow fan) and an electronic motor 3 serving as a driving source for the air blowing fan 2. The air blowing fan 2 and the electronic motor 3 are housed coaxially along the rotation axis L in a fan casing 4.

The air blowing fan 2 is a cross flow fan that can be rotated with the rotation axis L being used as a center axis, and a large number of fan blades 21 are arranged therein in a ring form along the axial direction. At both ends of the air blowing fan 2, end plates 22 and 23 for fixing both ends of the fan blades 21 are provided.

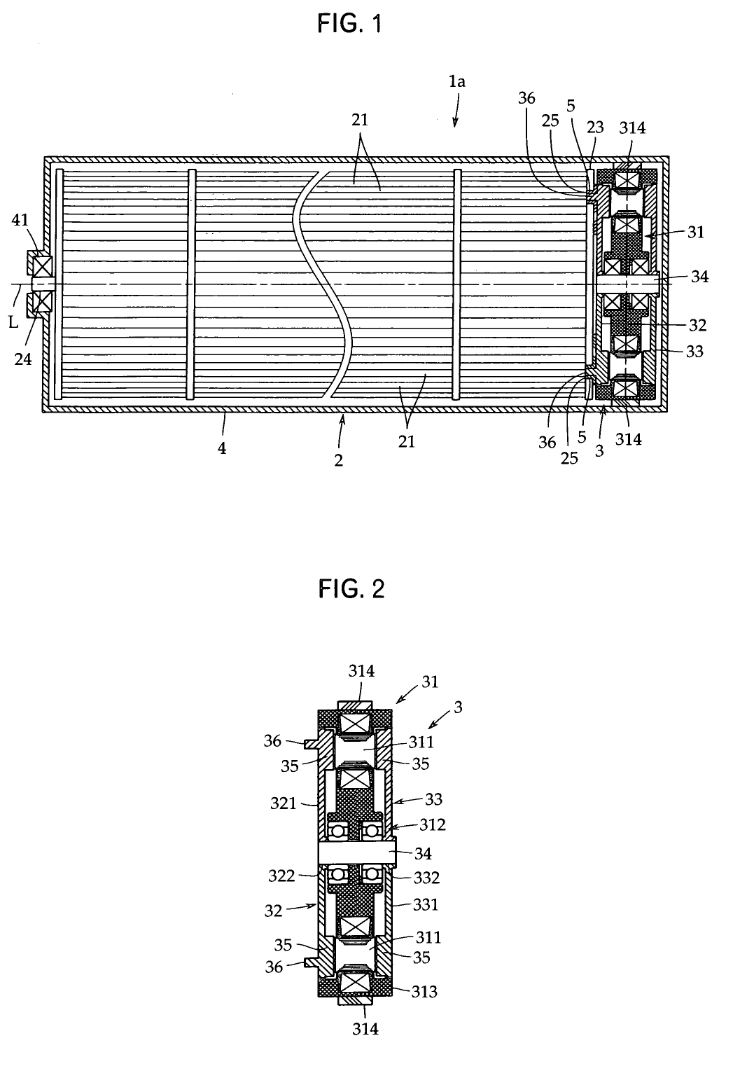

On one end plate 22 (left-hand side in FIG. 1), a rotating shaft 24 is provided coaxially along the axis L. The rotating shaft 24 is pivotally supported by a bearing 41 provided on the fan casing 4. By rotating the air blowing fan 2 with the rotating shaft 24 being used as the center axis, an air flow is produced in the radial direction of the air blowing fan 2.

In the other end plate 23 (right-hand side in FIG. 1) of the air blowing fan 2, there is provided an engagement concave portion 25, which is one connecting means for attaching the air blowing fan 2 to the electronic motor 3. The engagement concave portion 25 includes engagement holes formed in the end plate 23 at predetermined intervals on a concentric circle around the center axis L. By engaging an engagement convex portion 36 provided on the electronic motor 3 with the engagement concave portion 25, the electronic motor 3 and the air blowing fan 2 are connected to each other.

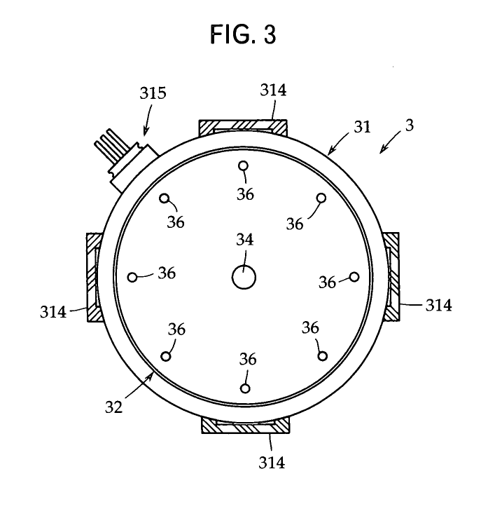

Next, referring to FIGS. 2 and 3, the electronic motor 3 is explained. The electronic motor 3 is what is called an axial gap electronic motor provided with a stator 31 formed in a disc shape and a pair of rotors 32 and 33 arranged opposedly on both side surfaces of the stator 31 with a predetermined gap being provided therebetween.

The rotors 32 and 33 are connected to each other coaxially by a connection shaft 34, and the connection shaft 34 is pivotally supported by a bearing 312 of the stator 2. In this embodiment, the electronic motor 3 is a permanent magnet electronic motor in which the rotors 32 and 33 each are provided with a rotor magnet 35.

The stator 31 has a stator core 311 formed in a ring shape at a position opposed to the rotor magnet 35 and the bearing 312 for pivotally supporting the connection shaft 34, which is provided in the center of the stator core 311. The stator core 311 and the bearing 312 are formed of a synthetic resin 313.

The stator core 311 has an iron core consisting of a laminated body of magnetic steel sheets, and a coil is wound on a bobbin in a multiple form with the iron core being the center. In the present invention, specific constructions of the stator core 311 and the bearing 312 are described later.

A necessary construction requirement of the present invention is the use of the two rotors 32 and 33 with respect to the stator 31. Specifically, usually, in the axial gap electronic motor, there is formed a magnetic circuit generating a loop such that a magnetic flux coming out of, for example, one magnet enters the iron core of the stator 31 via an air gap, and after being drawn by the opposite-side magnet pole via the air gap again, the magnetic flux returns to the opposite-side pole through a magnetic path or a yoke in the magnet.

However, in the case where one rotor is used, a portion opposed to the opposite-side magnet is a mere space. Therefore, only a mere magnetic resistance is present in this portion, and a magnetic field produced accordingly is small, so that a high torque is difficult to provide. Therefore, the present invention is based on the use of two rotors.

On the outer peripheral surface of the stator 31, there is formed a fixing portion 314 for fixing the stator 31 along the inner peripheral surface of the fan casing 4. In this embodiment, the fixing portion 314 is provided at four locations at intervals of 90 degrees so as to be in contact with the internal wall of the fan casing 4 of a square tubular shape.

The outer peripheral portion of the stator 31 is further provided with a connector portion 315 connected to a driver device, not shown, in order to energize a coil wound around the stator core 311.

The rotors 32 and 33 each have a disc-shaped rotor body 321, 331 fixed to the connection shaft 34 and the rotor magnet 35 supported by the rotor body 321, 331. The rotor magnet 35 includes a plurality of magnet chips, not shown, formed in a fan shape for each magnetic pole, and is assembled integrally to each of the rotor bodies 321, 331.

On the fan attaching surface of the rotor 32 on the side to which the air blowing fan 2 is attached (left-hand side in FIG. 2), the engagement convex portion 36, which is the other connecting means, is formed integrally. As shown in FIG. 3, the engagement convex portion 36 includes a plurality of cylindrical ribs projectingly provided on the attaching surface of the rotor 32, the cylindrical ribs being arranged at predetermined intervals (in this embodiment, eight ribs are provided at intervals of 45 degrees) on a concentric circle around the center axis.

According to this configuration, the air blowing fan 2 is engaged well with the rotor 32, so that the rotation torque produced by the rotor 32 can be transmitted surely to the air blowing fan 2. Also, since screwing etc. is not needed, the air blower apparatus can be manufactured at a low cost. Further, the positioning work is also unnecessary.

In this embodiment, the engagement convex portion 36 and the engagement concave portion 25, serving as connecting means, include round holes and cylindrical ribs. However, the rib may be formed in, for example, a ring shape. The shape is arbitrary if it can surely transmit the driving force of the electronic motor 3 to the air blowing fan 2. Also, these connecting means need not be arranged on a concentric circle if they are provided at positions at which they can be fitted to each other.

Between the air blowing fan 2 and the rotor 32, there is interposed a vibration-proof member 5 for preventing vibrations of the electronic motor 3 from propagating to the air blowing fan 2. The vibration-proof member 5 is made of a material having vibration damping properties, such as rubber. In this embodiment, the vibration-proof member 5 is formed in a disc sheet shape, and is attached integrally to the end plate 23 of the air blowing fan 2.

The vibration-proof member 5 absorbs a slight parallelism distortion produced between the end plate 23 of the air blowing fan 2 and the flat surface of the rotor 3, and also has a function as coming-off preventive means for surely holding the engagement convex portion 36 projectingly provided on the rotor 32 in the engagement concave portion 25 in the end plate 23.

Referring again to FIG. 1, the fan casing 4 is made of a molded product such as a synthetic resin, and is formed into a hollow tubular body extending in the axial direction. At the bottom (far side of paper in FIG. 1) of the fan casing 4, a blowoff hole (not shown) is provided to deliver an air flow generated by the air blowing fan 2 to the outside of the fan casing 4.

It is possible to connect the air blowing fan 2 to the rotor 32 without the use of the vibration-proof member 5. However, when the vibration-proof member 5 is not interposed, the noise-reducing properties decrease. Therefore, in such a case, by carrying out operation control such that a torque ripple at the time of rotation of the electronic motor 3 decreases, i.e., the operation control by sinusoidal wave drive for 120 to 180° wide-angle energization, the occurrence of vibrations can be restrained, and resultantly the noise-reducing properties can be increased. Further, by the sinusoidal wave drive, the effect in restraining vibrations can be increased. It is a matter of course that the interposing of the vibration-proof member 5 brings about a greater vibration-proof effect.

The inner peripheral surface of the fan casing 4 is formed in an arcuate shape along the outer peripheral surface of the air blowing fan 2, and the electronic motor 3 is supported along the inner peripheral surface of the fan casing 4 via the fixing portions 314. In this embodiment, the fan casing 4 is also used as a bracket for concealing the stator 31 and the rotors 32 and 33 of the electronic motor 3. According to this configuration, the cost can be kept low because a bracket for the electronic motor 3 is not needed.

The fixing portion 314 is preferably formed of an elastic material such as rubber. By doing this, the fixing portion 314 can effectively absorb vibrations produced by the electronic motor 3, and also functions to prevent the rotation of the electronic motor 3 with respect to the fan casing 4. The elastic material may be a plurality of materials or a single material, or may be plastics.

In order to use the fan casing 4 also as the bracket, it is preferable to prevent dust or water from entering the interior as far as possible. Therefore, the fan casing 4 is preferably subjected to protection treatment such as waterproofing treatment and dust-proofing treatment.

According to this configuration, by assembling the air blowing fan 2 and the electronic motor 3 integrally via the fan casing 4 and by using an axial gap electronic motor as the electronic motor 3, the length in the axial direction of the electronic motor 3 can be decreased, and accordingly the length in the axial direction of the air blowing fan 2 can be increased, so that the air blowing quantity can be increased.

Because the fan casing 4 functions as the bracket for the electronic motor 3, a bracket need not be provided specially, and accordingly, the assembling manpower and the production cost can be reduced.

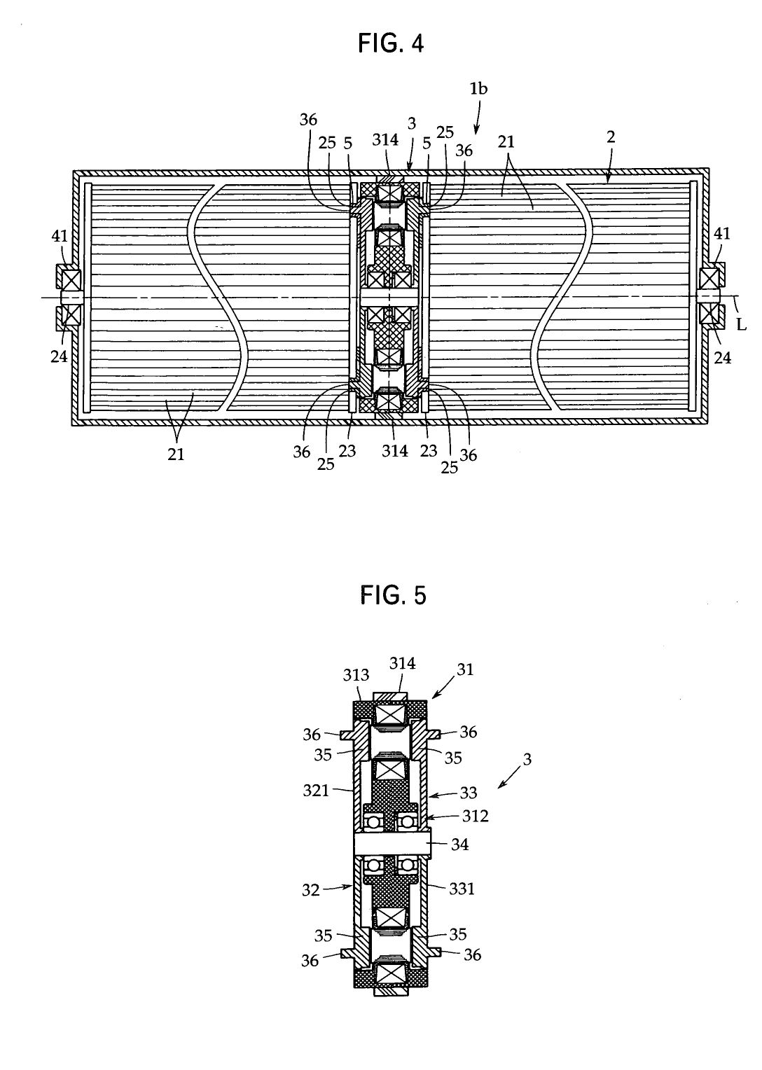

Although the air blowing fan 2 is installed to only one rotor 32 of the electronic motor 3 in the above-described first embodiment, the air blowing fan 2 may be installed to each of the rotors 32 and 33. Specifically, as shown in FIGS. 4 and 5, in an air blowing apparatus 1b, the electronic motor 3 is arranged in the center of the fan casing 4, and the air blowing fans 2, 2 are installed to the end surfaces of the rotors 32 and 33.

According to this configuration, two air blowing fans 2, 2 can be mounted to one electronic motor 3, so that not only the air blowing capacity can be increased, but also the rotation balance of the air blowing fans 2, 2 is good because the electronic motor 3 is arranged in the center. Such a mode is also embraced in the present invention.

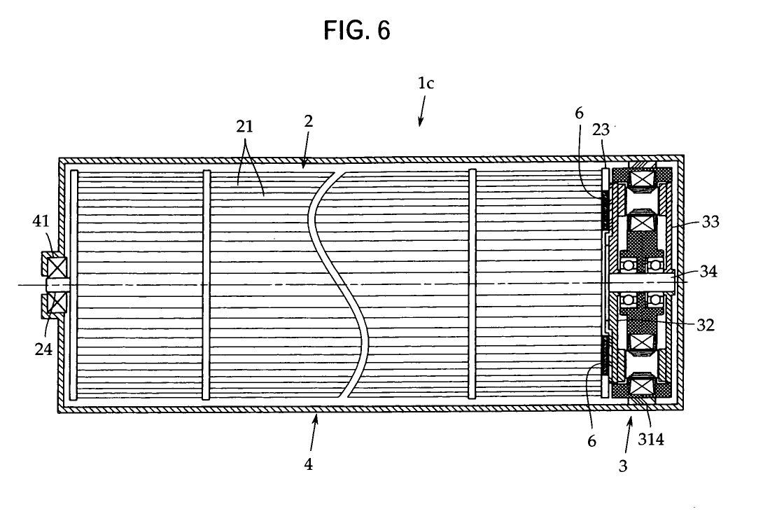

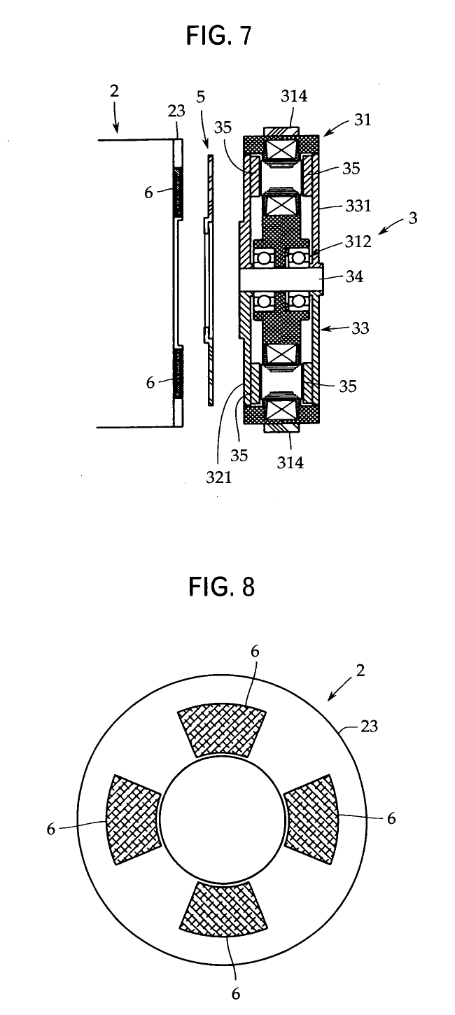

Also, in the above-described embodiment, the air blowing fan 2 and the electronic motor 3 are connected to each other via the engagement means consisting of an irregular portion. However, in the case where each of the rotors 32, 33 are a back yoke formed of a magnetic material, the air blowing fan 2 and the electronic motor 3 may be connected to each other by a method, for example, shown in FIGS. 6 to 8.

Specifically, in an air blowing apparatus Ic, the air blowing fan 2 and the electronic motor 3 are connected to each other via connecting means consisting of a magnet coupling. As shown in FIG. 8, on the end plate 23 of the air blowing fan 2, a fan-shaped magnet chip 6 is provided at four locations at angular intervals of 90 degrees in this embodiment.

The magnet chip 6 is generally formed by a ferrite-base or neodymium-base magnet or the like. However, the magnetic chip 6 may have any configuration if it can provide a magnetic force capable of transmitting the rotational drive force of the electronic motor 3 surely to the air blowing fan 2. Also, a yoke etc. can be mounted on the air blowing fan 2 side to increase the magnetic force. Also, the magnetic chip 6 may be affixed on the end plate 23 or may be embedded therein.

Between the air blowing fan 2 and the rotor 32 of the electronic motor 3, the vibration-proof member 5 is interposed to restrain vibrations. In this embodiment, the vibration-proof member 5 includes a flat disc-shaped ring body, and the central portion thereof is recessed along the end plate 23 of the air blowing fan 2.

An advantage of the use of the magnet coupling is the improvement in assembling ability. Specifically, the air blowing fan 2 can be fixed to the electronic motor 3 merely by installing the end plate 23 of the air blowing fan 2 along the rotor 32 of the electronic motor 3. Inversely, at the time of repair etc. as well, the disassembling ability is high. In employing the magnet coupling, positioning means may be provided separately to surely perform positioning at the time of installation.

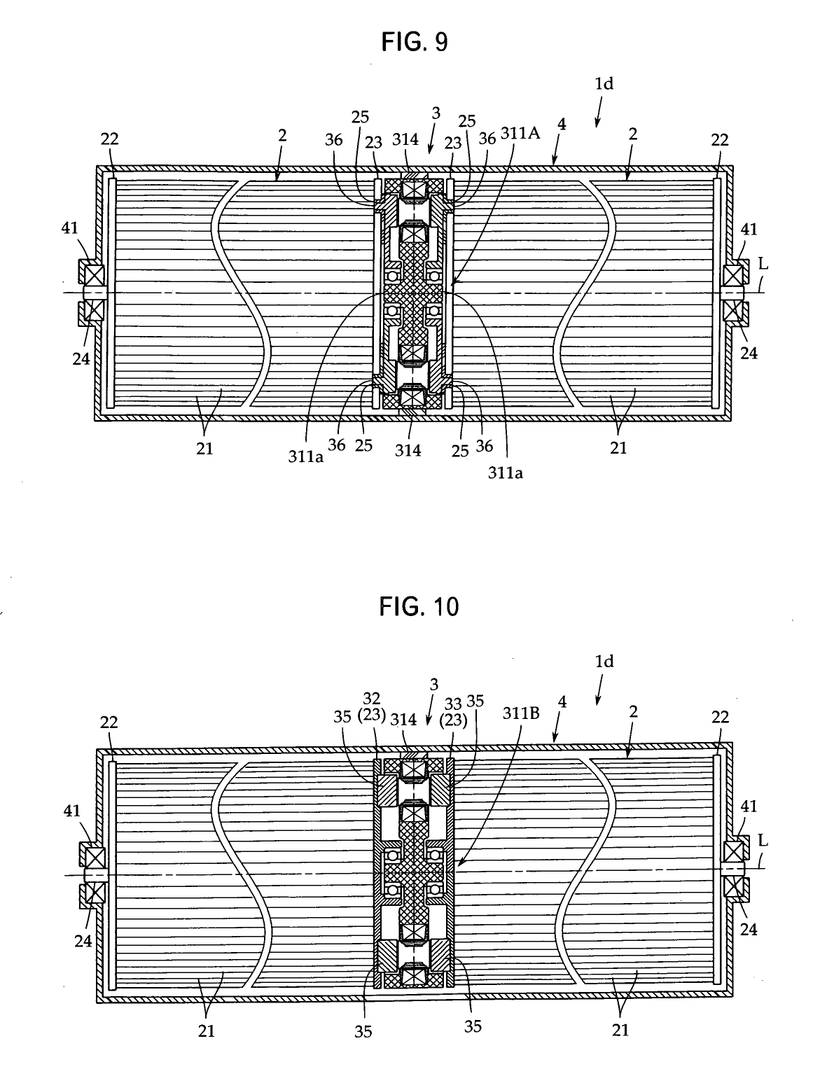

FIG. 9 shows an air blower apparatus in accordance with a second embodiment of the present invention. The feature of an air blower apparatus 1d is the bearing construction of the electronic motor 3. In this embodiment, the same reference numerals are applied to elements that are the same or regarded as the same as those in the above-described embodiment, and the explanation thereof is omitted.

The air blower apparatus 1d is an axial gap electronic motor in which the electronic motor 3 is provided projectingly with a boss 311a in the center on both sides of the stator 31, and the rotors 32 and 33 are supported via first and second bearings 311A, 311A each including a radial bearing, the connection shaft 34 rotating shaft) being not provided.

In this embodiment, the bearings 311A, 311A are configured so that the inner race of the radial bearing is fixed to the boss 311a of the stator 31, and the outer race thereof is fixed to the rotor side. However, the support positions of the inner race and outer race may be reversed.

According to this configuration, since the rotors 32 and 33 are held directly by the stator 31 via the radial bearing, the rotors 32 and 33 can be supported with a larger diameter as compared with the case where the connection shaft 34 is used for connection. Accordingly, the stability (bearing accuracy) of the rotors 32 and 33 is improved, so that the vibrations due to the rotation can be restrained effectively. Such a mode is also embraced in the present invention.

In the second embodiment, a radial bearing is used as bearing means, and the inner race thereof is fixed to the stator 31 and the outer race thereof is fixed to the rotors 32 and 33. However, the configuration may be such that, inversely, the inner race is fixed to the rotors and the outer race is supported by the stator.

FIG. 10 shows a modification of the second embodiment. In an air blower apparatus 1e, the rotor 32, 33 of the electronic motor 3 is also used as the end plate 23, 23 of the air blowing fan 2. Specifically, on the end plate 23 of the air blowing fan 2, the rotor magnet 35 for driving and a bearing 311B with respect to the stator 31 are formed integrally.

For the bearing 311B, the outer race of radial bearing is fixed, and the inner race of radial bearing is fitted on a boss projected from the stator 31. Thereby, the end plates 23, 23 of the air blowing fan 2 can be used as the rotors 32, 33, so that the length in the axial direction can further be decreased, and also the cost can be reduced.

In the above-described embodiments, the air blowing fans 2 are provided on the rotors 32 and 33 of the electronic motor 3 so as to be symmetric in the right-and-left direction. However, the configuration may be such that, for example, the air blowing fan 2 is provided on one rotor side, and another driving mechanism is provided on the other rotor side.

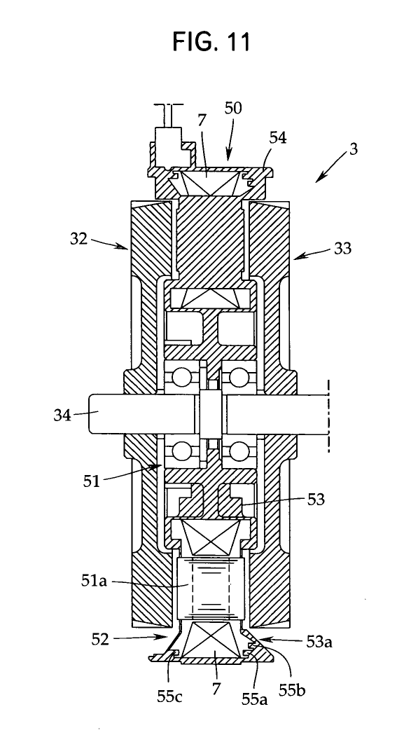

Next, referring to FIGS. 11 to 15, a stator construction of the electronic motor 3 used for the air blower apparatus of the above-described embodiments is explained. In this embodiment, the stator 50 has a construction having the output shaft 34, which connects the rotors 32 and 33 to each other, in the center (refer to FIG. 11).

The axial gap electronic motor 3 includes the stator 50 of a substantially disc shape and the paired rotors 32 and 33 which are arranged opposedly on both sides of the stator 50 with a predetermined gap being provided therebetween. The rotors 32 and 33 commonly have the same rotor output shaft 34, and the stator 2 is provided with a bearing 51 for supporting the rotor output shaft 34 on the inner periphery side of the stator 2. The axial gap electronic motor 3 is housed in the fan casing 4.

The stator 50 includes a stator core 52 formed in a ring shape (doughnut shape) and a bearing housing 53 coaxially inserted to the inner periphery side of the stator core 52, and these elements are integrally molded by a synthetic resin 54.

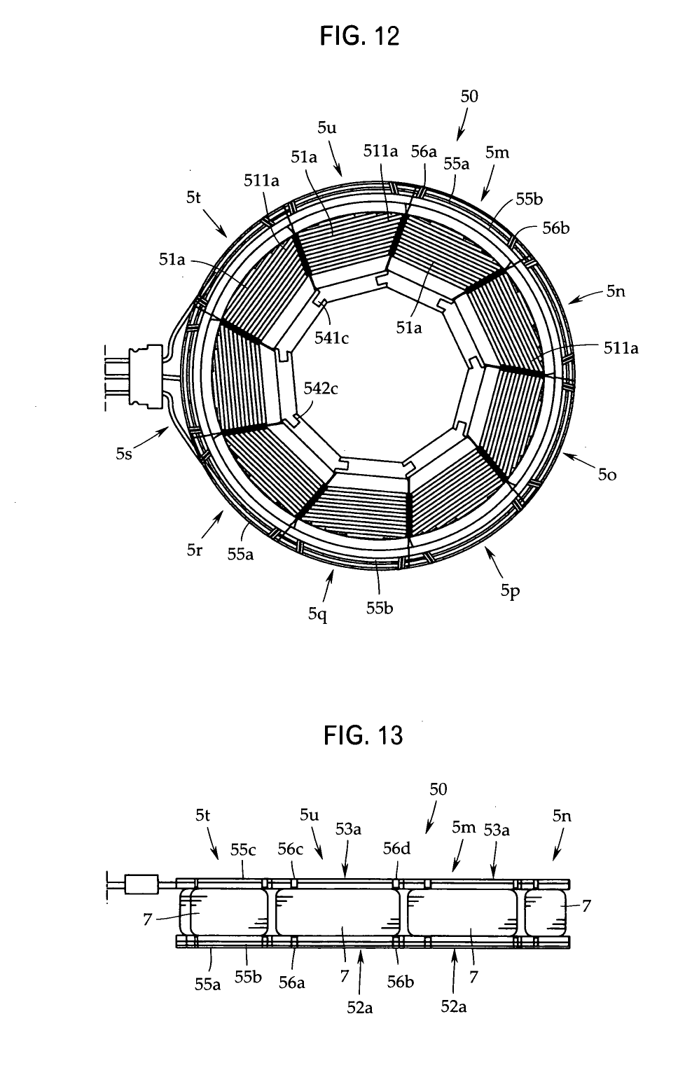

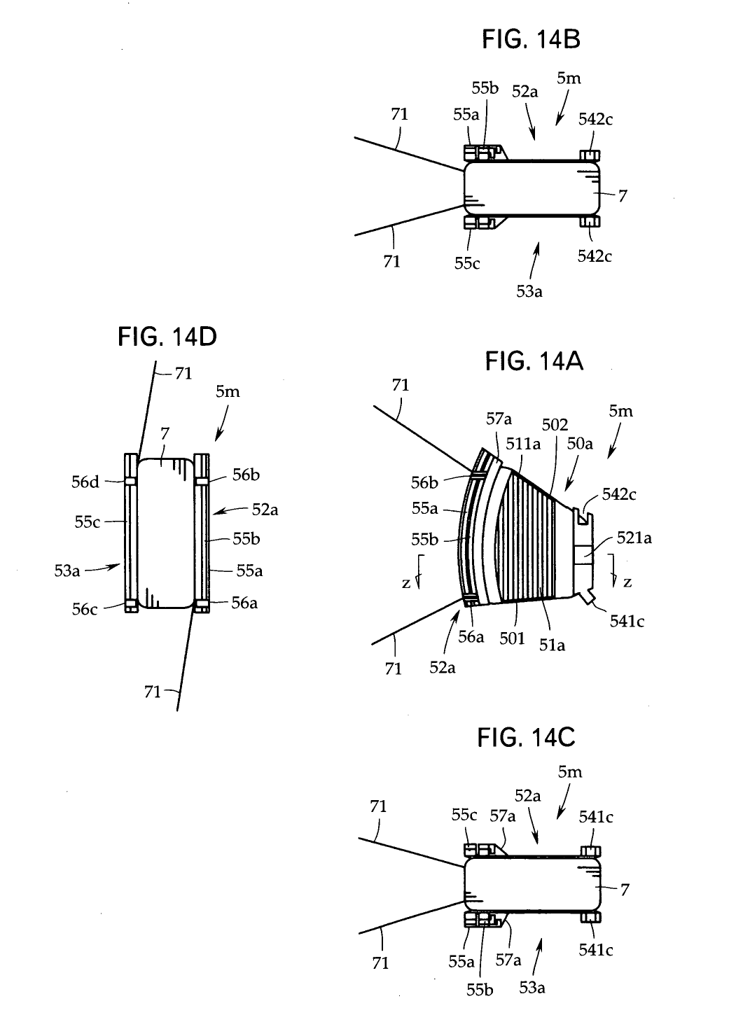

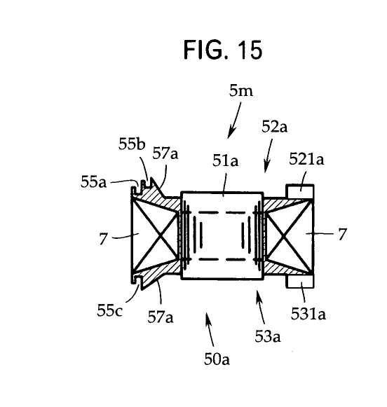

As shown in FIG. 12, the stator core 52 is formed by connecting a plurality of (nine slots in this example) core members 5m to 5u to each other in a ring shape. All of the core members 5m to 5u have the same shape, and therefore FIG. 14 shows one core member 5m as an example. FIGS. 14A, 14B, 14C and 15 are a front view of the core member 5m, a plan view thereof, a bottom view thereof, a left side view thereof, and a sectional view of a principal portion, respectively.

As shown in FIG. 14A, the core member 5m has teeth (iron core) 51a formed by laminating a plurality of magnetic steel sheets in the radial direction, and around the teeth 51a, an insulator 50a formed of a synthetic resin is integrally formed excluding both sides thereof (surface of iron core facing to the rotor). The provision of iron core increases the magnetic flux density, and can form a strong magnetic field near the rotors 32 and 33, so that the torque of electronic motor can be made high.

The insulator 50a can be formed by insert molding method in which the teeth 51a is put in a cavity in a mold, not shown, and molten resin is injected into the cavity. In this embodiment, as the molten resin, SPS (syndiotactic polystyrene) with relatively high flowability is used.

In this embodiment, the insulator 50a is formed by insert molding method using the teeth 51a. However, it may be formed by a method in which, for example, the insulator 50a is formed by two pieces in advance, and these two pieces are installed from both sides with the teeth 51a being held therebetween.

On the teeth 51a, there is formed a skew 511a inclined at a predetermined angle in the direction of rotation of the rotors 32 and 33, in this embodiment, in the clockwise direction. In this embodiment of 9 slots and 8 poles, the skew angle is set at 5 degrees. Thereby, the occurrence of cogging torque can be restrained, and hence the energy conversion efficiency is improved.

The skew 511a is formed in a straight line shape with respect to a gap surface between the adjacent core members. Besides, the skew 511a may have an arcuate shape. The shape thereof is not subject to any special restriction as long as it achieves an effect of effectively restraining cogging torque.

The insulator 50a is formed so that the whole thereof including substantially fan-shaped flanges 52a and 53a arranged in a pair in the right-and-left direction along both side surfaces of the teeth 51a has a bobbin form having an H-shaped cross section. By the presence of the insulator 50a, a coil 7 can be wound on the teeth 50a in a regular manner.

Each of the flanges 52a, 53a is provided with connecting means for connecting the adjacent core members to each other. In this example, the connecting means is provided on the inner periphery side of each of the flanges 52a, 53a.

The connecting means includes a boss 541c formed on the inner periphery side of one edge 501 of each of the flanges 52a, 53a and an engagement groove 542c formed on the inner periphery side of the other edge 502. By engaging these elements with each other, a ring-shaped stator core 50 as shown in FIG. 12 is formed.

In this embodiment, the boss 541c and the engagement groove 542c include a prismatic body and a rectangular groove corresponding to the prismatic body, respectively. By engaging the prismatic body with the rectangular groove, the connecting means can also be used as positioning means for the skew 511a.

In the side surfaces of the flanges 52a and 53a, a connecting wire storage groove 55a, 55b, 55c for treating a connecting wire 71 of the coil 7 is provided at three locations. In this embodiment, each of the connecting wire storage grooves 55a to 55c is formed in an arcuate shape along the outer periphery in the side surface of each of the flanges 52a, 53a. Two connecting wire storage grooves 55a and 55b are formed on one flange 52a side, and the remaining connecting wire storage groove 55c is formed on the other flange 53a side.

As shown in FIG. 15, each of the connecting wire storage grooves 55a to 55c consists of a U-shaped groove. More preferably, the storage groove should be designed so that the groove width of the opening portion is equal to or smaller than the groove width of the interior. This configuration achieves an effect of preventing the connecting wire 71 from coming off.

Each of the connecting wire storage grooves 55a to 55c is preferably configured so that the tip end portion (opening end side) thereof has a smaller thickness than other portions. In this configuration, when the core members 5m to 5u are integrated by a synthetic resin 54 after being connected to each other, the heat of molten resin propagates to the tip end portion, by which the tip end portion is softened to wrap the connecting wire 71 stored in the interior. Therefore, the effect of preventing the connecting wire 71 from coming off is further increased.

Also, in the case where the connecting wire storage groove 55a, 55b, 55c is provided at two or more locations, i.e., in the case where the groove is provided like the connecting wire storage grooves 55a and 55b shown in FIG. 15, the connecting wire storage grooves 55a and 55b are arranged so as to have a different height position via a step portion. The height position in this embodiment means a height in the axial direction.

In this embodiment, the connecting wire storage groove 55a on the outer periphery side is formed one step lower than the connecting wire storage groove 55b on the inner periphery side. According to this configuration, the molten resin flows in the mold cavity smoothly, so that the molten resin is allowed to flow uniformly without the formation of a void etc. between the stator core 52 and the synthetic resin 54.

An external wall surface 57a on the inner periphery side of the connecting wire storage groove on the inside diameter side (in this embodiment, the connecting wire storage grooves 55b and 55c) of the connecting wire storage grooves 55a to 55c preferably includes a tapered surface inclined in the radial direction. According to this configuration, the molten resin flowing from the center to the outer periphery side is allowed to flow to the outer periphery side more smoothly.

Further, as means for smoothening the flow of molten resin, resin introduction paths 521a and 531a are provided at a part of the flanges 52a and 53a to smoothen the flow of resin when the core members 5m to 5u are connected to and integrated with each other. The resin introduction path 521a, 531a includes a U-shaped groove formed on the inside diameter side of each of the flanges 52a, 53a along the radial direction, so that the molten resin flows from this groove to the outer peripheral portion after passing through the side surface of each of the flanges 52a, 53a.

In this embodiment, a resin introduction path 58a is provided at only one location along the radial direction on the inner periphery side of each of the flanges 52a, 53a. However, the resin introduction path 58a may be provided, for example, at a plurality of locations, and the number and shape thereof are not subject to any special restriction.

The connecting wire storage grooves 55a to 55c are provided with engagement grooves 56a to 56d cut along the radial direction. The engagement grooves 56a to 56d are provided at two locations of the connecting wire storage grooves 55a to 55c. By hooking a part of the connecting wire 71 to each of the engagement grooves 56a to 56d, the connecting wire 71 is prevented from being unfastened, for example, at the time of transportation.

In the procedure for assembly and wiring of the stator cores 5m to 5u, in order to generate a rotating magnetic field, in the case of the nine slot type, it is necessary to arrange the U, V and W phases in the order of (+)→(−)→(+), and it is necessary to make the winding direction of the center stator core reverse, or to connect the wire reversely. For example, when 5m, 5n and 5o are in a U phase, 5p, 5q and 5r are in a V phase, and 5s, 5t and 5u are in a W phase, winding is performed so that 5m is (+), 5n is (−), and 5o is (+).

After the stator cores 5m to 5u are assembled, the stator 2 is formed by insert molding method using the synthetic resin 21. Usually, the resin is caused to flow from the center of the stator 2 into the cavity in a molten state, and to flow toward the outer periphery side. In this embodiment, contrivance is made to smoothen the flow of molten resin; for example, the connecting wire storage grooves 55a to 55c are provided in the side surface of the flanges 32a and 33a, or the tapered surface is provided, so that the stator 2 having more homogeneous properties can be obtained.

Thus, when the core members are fixed permanently by the synthetic resin 54 finally, a second connecting means provided on the inner periphery side of the core member is not necessarily needed. Also, although the paired rotors 32 and 33 are provided in the above-described example, a one-side rotor may be provided. Thus, the present invention embraces various changes and modifications without departing from the spirit of the invention and within the scope of being equivalent technically.

1. An air blower apparatus in which an electronic motor and an air blowing fan are assembled integrally via predetermined connecting means, wherein said electronic motor is an axial gap electronic motor in which a rotor and a stator are arranged opposedly with a predetermined gap along the rotation axis direction of said rotor; said rotor is provided in a pair at the right and left with respect to said stator; and to at least one of said rotors, said air blowing fan is coaxially attached via said connecting mean.

2. The air blower apparatus according to claim 1, wherein said connecting means includes an engagement convex portion formed on either one of the attaching surfaces of said rotor and said air blowing fan and an engagement concave portion formed in the other of them as an mating element of said engagement convex portion.

3. The air blower apparatus according to claim 1, wherein said connecting means is a magnet coupling.

4. The air blower apparatus according to claim 1, wherein a bearing is provided in a central portion of said stator, and said rotor is supported by said bearing via a radial bearing.

5. The air blower apparatus according to claim 1, wherein the control of said electronic motor is wide-angle energization not smaller than 120° and smaller than 180°.

6. The air blower apparatus according to claim 1, wherein a fan casing for covering said air blowing fan is further provided, and said fan casing is also used as a bracket for fixing said stator.

7. The air blower apparatus according to claim 6, wherein an elastic member is interposed between said air blowing fan and said fan casing.

8. The air blower apparatus according to claim 1, wherein said rotor is also used as one end plate in the axial direction of said air blowing fan.

9. The air blower apparatus according to claim 7, wherein said fan casing is subjected to drip-proofing treatment and/or dust-proofing treatment.

10. The air blower apparatus according to claim 1, wherein said stator has a plurality of core members each having a stator iron core in the interior, and said core members are connected to each other in a ring shape along the direction of rotation of said rotor.

11. The air blower apparatus according to claim 10, wherein each of said core members is formed with a bobbin-shaped insulator including a flange for winding a coil, and said insulator is provided with core connecting means for connecting the adjacent core members to each other.
